(19) United States
(12) Patent Application Publication
(10) Pub. No.: US 2026/0174629 A1
(43) Pub. Date: Jun. 25, 2026

(54) MASSAGE SPACING ADJUSTING STRUCTURE AND SHOULDER-NECK MASSAGE MACHINE CORE

(71) Applicant: Xiamen Emoka Health Science & Technology Co., Ltd., Xiamen (CN)

(72) Inventors: Guanghua ZHOU, Xiamen (CN); Jiaxian LIAO, Xiamen (CN)

(21) Appl. No.: 19/534,964

(22) Filed: Feb. 10, 2026

(30) Foreign Application Priority Data
Jul. 9, 2025 (CN) 202521425804.6

(51) Int. Cl. A61H 23/02; A61H 7/00; A61H 23/00; B60N 2/30

(52) U.S. Cl. CPC A61H 23/0263; A61H 7/004; A61H 23/006; A61H 23/0254; B60N 2/3065; A61H 2201/0149; A61H 2201/1215; A61H 2201/1669

(57) ABSTRACT

The present disclosure discloses a massage spacing adjusting structure and a shoulder-neck massage machine core. The adjusting structure includes an adjusting motor, a transmission assembly, a limiting mechanism, as well as adjusting screw rods, adjusting seats and connecting seats symmetrically arranged on a long rotating shaft. The adjusting seats are in threaded fit with the adjusting screw rods. The motor drives the adjusting seats to rotate so as to drive the screw rods and massage assemblies to extend or retract for spacing adjustment. The motor is reversed by conducting probes and conducting electrode plates, so that stepless adjustment of a width of the massage assemblies within a set stroke is achieved, and the application scope is expanded.

### CROSS-REFERENCE TO RELATED APPLICATIONS

This application claims the benefit of priority from Chinese Patent Application No. 202521425804.6, filed on Jul. 9, 2025. The content of the aforementioned application, including any intervening amendments thereto, is incorporated herein by reference in its entirety.

### TECHNICAL FIELD

The present disclosure relates to the technical field of massagers, in particular to a massage spacing adjusting structure and a shoulder-neck massage machine core.

### BACKGROUND

With the progress of society and the rapid development of science and technology, the pace of people's work and life is constantly accelerating. All social strata are busy pursuing a better life, leaving little time for physical exercise, and people's physical health index is declining steadily. This situation is particularly severe among office workers who spend long hours in front of computers, drivers who sit for extended periods in the drivers'cabs and other such groups. Prolonged desk work or constant staring at computers leads to severe muscle strain in the necks and shoulders, and poor circulation of qi and blood, and is likely to trigger diseases such as scapulohumeral periarthritis and cervical hyperosteogeny.

At present, a large number of auxiliary therapeutic devices for the above health problems—neck-shoulder massagers—have appeared on the market. Using a neck-shoulder massager can massage and relax the muscles of the neck and shoulder area in a short time, and persistent use can effectively relieve pain symptoms. However, the neck and shoulder dimensions vary among different groups of people, some have relatively thick necks and shoulders, while others have relatively thin ones. Most existing neck-shoulder massagers adopt a fixed massage mode, that is, the spacing between massage heads on the left and right sides of the neck-shoulder massager is fixed and cannot be adjusted according to the actual needs of users, resulting in a relatively limited applicable population.

In view of the above, the present disclosure is developed based on an in-depth conception of the numerous defects and inconveniences caused by the imperfect structural design of existing neck-shoulder massagers, as well as active research, improvement and trial production.

### SUMMARY

An objective of the present disclosure is to overcome the shortcoming that a massage spacing cannot be adjusted in the prior art, and provide a massage spacing adjusting structure capable of adjusting a spacing between two massage assemblies.

In order to implement the above objective, a solution of the present disclosure is as follows.

The massage spacing adjusting structure includes an adjusting motor, an adjusting transmission assembly, two adjusting screw rods, two adjusting seats, two connecting seats and a limiting mechanism. The adjusting transmission assembly connects the adjusting motor and the two adjusting seats, and the two adjusting screw rods, the two adjusting seats and the two connecting seats are symmetrically arranged on a long rotating shaft of the massage machine core respectively. The adjusting seats are connected to the adjusting transmission assembly, a center of each adjusting seat has an internal thread, the adjusting screw rods have external threads in threaded fit with the internal threads of the adjusting seats, one end of each adjusting screw rod is connected to the corresponding adjusting seat, and the other end thereof and a massage assembly are fixed together through the corresponding connecting seat. The limiting mechanism includes conducting probes and conducting electrode plates, the conducting probes are connected to a circuit board, the conducting electrode plates synchronously move with the adjusting screw rods, a distance between the two conducting probes is less than or equal to a length of the external thread of each adjusting screw rod, and the conducting electrode plates are located between the two conducting probes.

Further, the adjusting transmission assembly adopts a gear set for transmission, and includes an adjusting drive gear, an adjusting transmission shaft and adjusting transmission gears. The adjusting drive gear is meshed with an output shaft of the adjusting motor, the adjusting drive gear is fixedly arranged in the middle of the adjusting transmission shaft, two ends of the adjusting transmission shaft are each connected with one adjusting transmission gear, and peripheries of the adjusting seats have adjusting gears meshed with the adjusting transmission gears.

Further, the adjusting transmission shaft is provided with a bearing located between the adjusting drive gear and each of the two adjusting transmission gears, the bearings are arranged on bearing seats, and the bearing seats are fixed onto a shell.

Further, each connecting seat includes a first clamping ring, a second clamping ring and a connecting member, one end of the connecting member and the massage assembly are locked together, and the other end of the connecting member is provided with a first mounting ring. One end of each adjusting screw rod connected to the corresponding connecting seat has a second mounting ring, clamping grooves corresponding to the first mounting ring and the second mounting ring are formed in the first clamping ring and the second clamping ring, and when the first clamping ring and the second clamping ring are buckled, the first mounting ring and the second mounting ring are limited in the clamping grooves, so that the massage assembly and the adjusting screw rods are fixed together.

Further, the conducting electrode plates are mounted on the second clamping rings of the connecting seats, guide rails extend from the second clamping rings towards one end of each adjusting screw rod, the guide rails are provided with electrode plate inserting seats extending towards one end of each conducting probe, and the conducting electrode plates are mounted on the electrode plate inserting seats.

Another objective of the present disclosure is to overcome the shortcoming that a massage spacing cannot be adjusted in the prior art, and provide a shoulder-neck massage machine core with a massage spacing adjustable.

In order to implement the above objective, a solution of the present disclosure is as follows.

The shoulder-neck massage machine core includes a shell, a battery, a massage motor, a circuit board, a massage transmission assembly, a long rotating shaft, massage assemblies and the massage spacing adjusting structure. The battery and the massage motor are connected to the circuit board, the massage transmission assembly connects the massage motor and the long rotating shaft, the long rotating shaft is driven to rotate by a gear transmission set, the two massage assemblies are symmetrically arranged on the long rotating shaft, an adjusting motor is mounted on the shell located on one side of the long rotating shaft, and conducting probes are mounted on the shell.

Further, each massage assembly includes an ejector rod, an eccentric wheel, a deflection wheel and a swing arm, a first limiting column is arranged at a bottom end of the ejector rod, a second limiting column is arranged at a bottom end of the swing arm, and the shell is provided with moving grooves for the first limiting column and the second limiting column to move. The eccentric wheel is provided with an eccentric hole, and is further provided with a long limiting groove communicating with the eccentric hole, the long rotating shaft is provided with two pin holes located at positions corresponding to two ends of the long limiting groove, and the eccentric wheel and the long rotating shaft are fixed together by limiting pins inserted into the two pin holes and the long limiting groove. The eccentric wheel is sleeved with the ejector rod, one end of the ejector rod abuts against the eccentric wheel, the other end thereof and connecting members of connecting seats are locked together, and the ejector rod is positioned on the eccentric wheel through the connecting members. One end of the eccentric wheel is connected to the ejector rod, the other end thereof is connected to an eccentric wheel connecting sheet which is used to fixedly connect the deflection wheel and the eccentric wheel together, one end of the deflection wheel and the eccentric wheel connecting sheet are fixed together, and the other end thereof is provided with a deflection shaft. One end of the swing arm is provided with a deflection hole corresponding to the deflection shaft, the deflection shaft is sleeved with the deflection hole, one end of the deflection wheel facing away from the deflection shaft forms a deflection slope, and a deflection massage head is mounted at a top end of the swing arm.

Further, the massage transmission assembly includes a drive gear and a transmission gear, the drive gear is a dual gear having a helical gear and a spur gear, the helical gear is meshed with an output shaft of the massage motor, the spur gear is connected and meshed with the transmission gear, and the transmission gear and the long rotating shaft are fixed together.

Further, a minimum spacing D1 of the two deflection massage heads of the two massage assemblies is greater than or equal to 56 mm; a minimum spacing D2 of the two ejector rods is greater than or equal to 57 mm; a maximum spacing D3 of the two deflection massage heads is less than or equal to 133 mm; and a maximum spacing D4 of the two ejector rods is less than or equal to 75 mm.

After the above structures are adopted, in the shoulder-neck massage machine core of the present disclosure, the adjusting transmission assembly and the adjusting seats are driven to rotate by forward or reverse rotation of the adjusting motor, when the two adjusting seats rotate, the two adjusting screw rods in threaded fit with the two adjusting seats move outwards or inwards, and when the adjusting screw rods move, the conducting electrode plates are driven to move. When the conducting electrode plates make contact with the conducting probes, the conducting probes are powered on, the circuit board senses a power-on signal and enables the adjusting motor to reverse, and thus the massage assemblies move left and right within a travel range of the two conducting probes. Further, the two massage assemblies connected to the two adjusting screw rods are driven to expand outwards or contract inwards, so that the distance between the two massage assemblies is adjusted. When the two massage assemblies are adjusted to a required width, the adjusting motor is stopped working, and then the width can be randomly adjusted within a length range between two conducting elastic sheets. The present disclosure can adapt to consumers with different figures, the application scope of the present disclosure is expanded, and the market competitiveness is improved.

### BRIEF DESCRIPTION OF DRAWINGS

FIG. 1 is a schematic exploded view of a shoulder-neck massage machine core of the present disclosure.

FIG. 2 is a schematic diagram of a massage spacing adjusting structure of the present disclosure.

FIG. 3 is a schematic combined sectional view of a shoulder-neck massage machine core of the present disclosure.

FIG. 4 is a schematic structural diagram of an adjusting screw rod and a connecting seat of the present disclosure.

FIG. 5 is a schematic exploded structure view of a massage assembly of the present disclosure.

FIG. 6 is a schematic diagram of an appearance with a narrowest massage spacing of the present disclosure.

FIG. 7 is a schematic diagram of an appearance with a widest massage spacing of the present disclosure.

### REFERENCE NUMERALS

1, shell; 11, moving groove; 2, battery; 3, massage motor; 4, circuit board; 5, massage transmission assembly; 6, long rotating shaft; 7, massage assembly; 71, ejector rod; 711, first limiting column; 712, plug; 72, eccentric wheel; 721, eccentric hole; 722, long limiting groove; 73, deflection wheel; 731, deflection shaft; 732, deflection slope; 74, swing arm; 741, second limiting column; 742, deflection hole; 75, eccentric wheel connecting sheet; 8, massage spacing adjusting structure; 81, adjusting motor; 82, adjusting transmission assembly; 821, adjusting drive gear; 822, adjusting transmission shaft; 823, adjusting transmission gear; 824, bearing; 825, bearing seat; 83, adjusting screw rod; 831, external thread; 832, second mounting ring; 84, adjusting seat; 841, internal thread; 842, adjusting gear; 85, connecting seat; 851, first clamping ring; 852, second clamping ring; 853, connecting member; 854, first mounting ring; 855, clamping groove; 856, guide rail; 857, electrode plate inserting seat; 86, limiting mechanism; 861, conducting probe; and 862, conducting electrode plate.

### DETAILED DESCRIPTION

In order to further explain the technical solution of the present disclosure, the present disclosure is described in detail below through specific embodiments.

In the description of the present disclosure, it should be understood that the terms such as “center,” “longitudinal,” “transverse,” “upper,” “lower,” “front,” “rear,” “left,” “right,” “vertical,” “horizontal,” “top,” “bottom,” “inner” and “outer,” which indicate the orientation or positional relationships, are based on the orientation or positional relationships illustrated in the accompanying drawings. These terms are only used for the convenience of describing the present disclosure and simplifying the description, and do not indicate or imply that the referred device or element must have a specific orientation, or be constructed and operated in a specific orientation. Therefore, such terms shall not be construed as a limitation to the present disclosure. In the description of the present disclosure, unless otherwise stated, “a plurality of” means two or more.

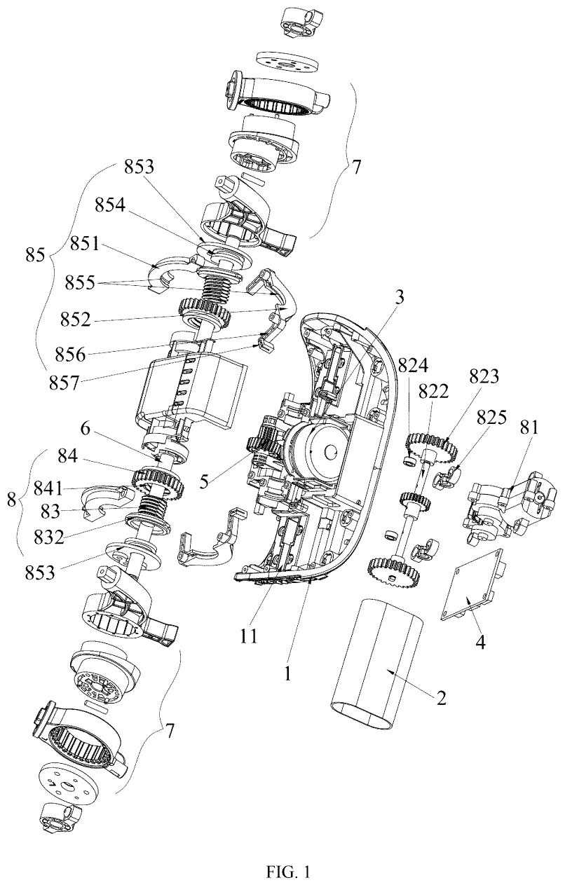

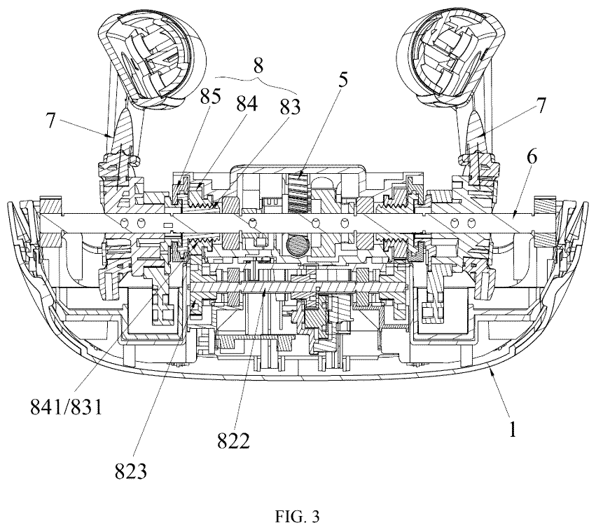

As shown in FIG. 1 to FIG. 5, the present disclosure discloses a shoulder-neck massage machine core, including a shell 1, a battery 2, a massage motor 3, a circuit board 4, a massage transmission assembly 5, a long rotating shaft 6, massage assemblies 7 and a massage spacing adjusting structure 8. The battery 2 and the massage motor 3 are connected to the circuit board 4, the massage transmission assembly 5 connects the massage motor 3 and the long rotating shaft 6, the long rotating shaft 6 is driven to rotate by the massage transmission assembly 5, and the two massage assemblies 7 are symmetrically arranged on the long rotating shaft 6. The massage spacing adjusting structure 8 includes an adjusting motor 81, an adjusting transmission assembly 82, two adjusting screw rods 83, two adjusting seats 84, and two connecting seats 85. The adjusting motor 81 is mounted on the shell 1 on one side of the long rotating shaft 6. The adjusting transmission assembly 82 connects the adjusting motor 81 and the two adjusting seats 84, and the two adjusting screw rods 83, the two adjusting seats 84 and the two connecting seats 85 are symmetrically arranged on the long rotating shaft 6 respectively. The adjusting seats 84 are connected to the adjusting transmission assembly 82, a center of each adjusting seat 84 has an internal thread 841, the adjusting screw rods 83 have external threads 831 in threaded fit with the internal threads 841 of the adjusting seats 84, one end of each adjusting screw rod 83 is connected to the corresponding adjusting seat 84, and the other end thereof and the corresponding massage assembly 7 are fixed together through the corresponding connecting seat 85. Forward or reverse rotation of the adjusting motor 81 drives the adjusting transmission assembly 82 to move, the adjusting transmission assembly 82 drives the two adjusting seats 84 to rotate forwards or reversely, when the adjusting seats 84 rotate, the adjusting screw rods 83 are driven to move close to or away from the adjusting seats 84, and then the two massage assemblies 7 connected to the two adjusting screw rods 83 are driven to move close to or away from each other, so that a spacing between the two massage assemblies 7 is increased or decreased to achieve the adjustment of a massage spacing.

In the present disclosure, the adjusting screw rods 83 and the adjusting seats 84 in threaded fit with each other are arranged on the long rotating shaft 6, the adjusting screw rods 83 are connected to the massage assemblies 7, the adjusting seats 84 are driven to rotate by the adjusting transmission assembly 82, and the adjusting screw rods 83 in threaded connection fit with the adjusting seats 84 are driven to rotate so as to adjust a width of the massage assemblies 7. When the adjusting screw rods 83 move outwards to an outer end of the long rotating shaft 6, a distance between the two massage assemblies 7 is gradually increased, and when the adjusting screw rods 83 move towards the center of the long rotating shaft 6, the distance between the two massage assemblies 7 is gradually decreased. A user can adjust the spacing between the two massage assemblies 7 according to own requirements, the application scope of the present disclosure is expanded, and the market competitiveness is improved.

The massage spacing adjusting structure 8 is further provided with a limiting mechanism 86 used to limit an adjusting range of the adjusting screw rods 83. In this embodiment, the limiting mechanism 86 includes conducting probes 861 and conducting electrode plates 862, the conducting probes 861 are connected to the circuit board 4, the conducting electrode plates 862 synchronously move with the adjusting screw rods 83, may be mounted on the adjusting screw rods 83 or mounted on the connecting seats 85 or the massage assemblies 7, and may reciprocate with the adjusting screw rods 83, the two conducting probes 861 are arranged on the shell 1, and the conducting electrode plates 862 are located between the two conducting probes 861. When the adjusting screw rods 83 move, the conducting electrode plates 862 are driven to move. When the conducting electrode plates 862 make contact with the conducting probes 861, the conducting probes 861 are powered on, the circuit board 4 senses a power-on signal and enables the adjusting motor 81 to reverse, and thus the massage assemblies 7 move left and right within a travel range of the two conducting probes 861, and the distance between the two massage assemblies 7 is adjusted.

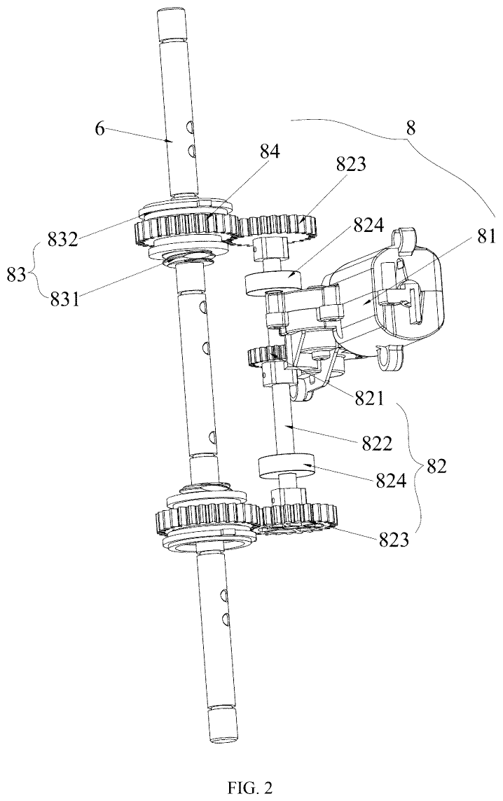

The adjusting transmission assembly 82 may adopt a gear set for transmission or belt pulleys for transmission. As shown in FIG. 1 and FIG. 2, in this embodiment, the adjusting transmission assembly 82 adopts gears for transmission and includes an adjusting drive gear 821, an adjusting transmission shaft 822 and adjusting transmission gears 823. The adjusting drive gear 821 is meshed with an output shaft of the adjusting motor 81, the adjusting drive gear 821 is fixedly arranged in the middle of the adjusting transmission shaft 822, two ends of the adjusting transmission shaft 822 are each connected with one adjusting transmission gear 823, and peripheries of the adjusting seats 84 have adjusting gears 842 meshed with the adjusting transmission gears 823. After driving of the adjusting motor 81, the output shaft thereof drives the adjusting drive gear 821 meshed with it to rotate, the adjusting drive gear 821 drives the adjusting transmission shaft 822 and the adjusting transmission gears 823 to rotate synchronously, then the adjusting transmission gears 823 drive the adjusting gear 842 meshed with them to rotate, and thus relative movement between the adjusting screw rods 83 and the adjusting seats 84 is realized.

Preferably, the adjusting transmission shaft 822 is provided with a bearing 824 located between the adjusting drive gear 821 and each of the two adjusting transmission gears 823, the bearings 824 are arranged on bearing seats 825, and the bearing seats 825 are fixed onto the shell 1. Through the bearings, frictional resistance of the adjusting transmission shaft 822 can be lowered, and energy losses are reduced. In addition, the bearings 824 can further provide precise radial and axial positioning for the adjusting transmission shaft 822, limit radial and axial displacements of the adjusting transmission shaft 822, and ensure that the adjusting transmission shaft 822 stably rotates on a preset trajectory.

In this embodiment, each connecting seat 85 includes a first clamping ring 851, a second clamping ring 852 and a connecting member 853, one end of the connecting member 853 and the massage assemblies 7 are locked together, and the other end of the connecting member 853 is provided with a first mounting ring 854. One end of each adjusting screw rod 83 connected to the corresponding connecting seat 85 has a second mounting ring 832, clamping grooves 855 corresponding to the first mounting ring 854 and the second mounting ring 832 are formed in the first clamping ring 851 and the second clamping ring 852, and when the first clamping ring 851 and the second clamping ring 852 are buckled, the first mounting ring 854 and the second mounting ring 832 are limited in the clamping grooves 855, so that the massage assemblies 7 and the adjusting screw rods 83 are fixed together.

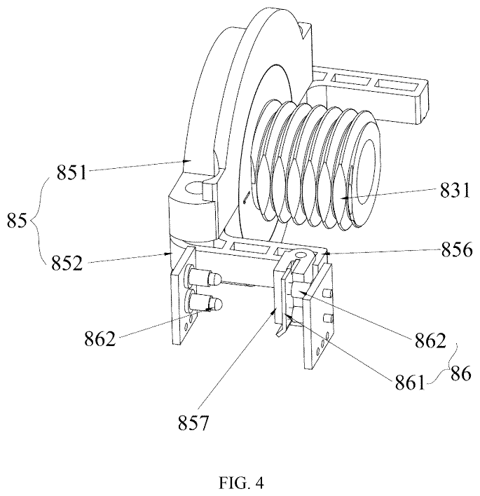

With reference to FIG. 4, there are many mounting manners for the conducting electrode plates 862. In this embodiment, the conducting electrode plates 862 are mounted on the second clamping rings 852 of the connecting seats 85, guide rails 856 extend from the second clamping rings 852 towards one end of each adjusting screw rod 83, the guide rails 856 are provided with electrode plate inserting seats 857 extending towards one end of each conducting probe 861, and the conducting electrode plates 862 are mounted on the electrode plate inserting seats 857.

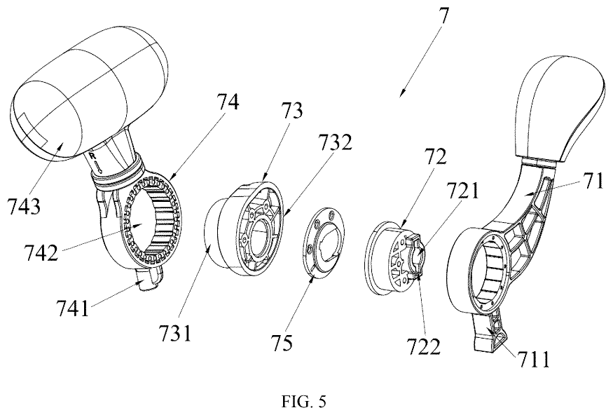

As shown in FIG. 5, in this embodiment, each massage assembly 7 includes an ejector rod 71, an eccentric wheel 72, a deflection wheel 73 and a swing arm 74, a first limiting column 711 is arranged at a bottom end of the ejector rod 71, a second limiting column 741 is arranged at a bottom end of the swing arm 74, and the shell 1 is provided with moving grooves 11 for the first limiting column 711 and the second limiting column 741 to move. The eccentric wheel 72 is provided with an eccentric hole 721, and is further provided with a long limiting groove 722 communicating with the eccentric hole 721, the long rotating shaft is provided with two pin holes located at positions corresponding to two ends of the long limiting groove 722, and the eccentric wheel 72 and the long rotating shaft 6 are fixed together by limiting pins inserted into the two pin holes and the long limiting groove 722. The eccentric wheel 72 is sleeved with the ejector rod 71, one end of the ejector rod 71 abuts against the eccentric wheel 72, the other end thereof and the connecting members 853 of the connecting seats 85 are locked together, and the ejector rod 71 is positioned on the eccentric wheel 72 through the connecting members 853. One end of the eccentric wheel 72 is connected to the ejector rod 71, the other end thereof is connected to an eccentric wheel connecting sheet 75 which is used to fixedly connect the deflection wheel 73 and the eccentric wheel 72 together, one end of the deflection wheel 73 and the eccentric wheel connecting sheet 75 are fixed together, and the other end thereof is provided with a deflection shaft 731. One end of the swing arm 74 is provided with a deflection hole 742 corresponding to the deflection shaft 731, the deflection shaft 731 is sleeved with the deflection hole 742, one end of the deflection wheel 73 facing away from the deflection shaft 731 forms a deflection slope 732, and a deflection massage head 75 is mounted at a top end of the swing arm 74. In this embodiment, the massage transmission assembly 5 includes a drive gear and a transmission gear (blocked by a motor lid in FIG. 1), the drive gear is a dual gear having a helical gear and a spur gear, the helical gear is meshed with an output shaft of the massage motor 3, the spur gear is connected and meshed with the transmission gear, and the transmission gear and the long rotating shaft 6 are fixed together.

When the massage machine core with the massage spacing adjustable of the present disclosure operates, the battery supplies power to the circuit board, the circuit board controls the massage motor 3 to work, the massage motor 3 drives the drive gear meshed with it to rotate during driving, the drive gear drives the transmission gear and the long rotating shaft 6 to rotate, and the long rotating shaft 6 drives the eccentric wheels 72 and the deflection wheels 73 to rotate so as to drive the ejector rods 71 to rotate. The ejector rods 71 are limited by the second limiting columns 741, so that free ends of the ejector rods 71 move up and down within a certain range. Since the deflection wheels 73 have the deflection slopes 732, under the action of the first limiting columns 711, the swing arms 74 sleeving the deflection shafts 731 can swing left and right when the long rotating shaft 6 rotates, achieving a function of clamping the neck. Then, with the cooperation with the ejector rods 71, the massage effects of kneading and pinching can be achieved. Forward or reverse rotation of the adjusting motor 81 can adjust the distance between the two massage assemblies 7.

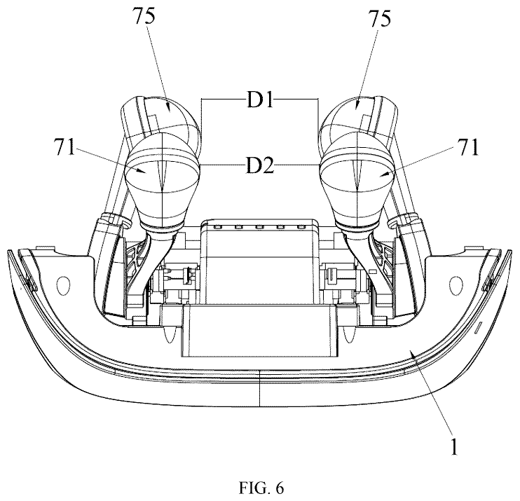

As shown in FIG. 6, when the massage assemblies 7 of the present disclosure are driven by the adjusting screw rods 83 to move to be close to the conducting probe 861 on one side of the center of the long rotating shaft 6, the spacing between the two deflection massage heads 75 and the spacing between the two ejector rods 71 of the two massage assemblies 7 are both the minimum, wherein a minimum spacing D1 of the two deflection massage heads 75 is greater than or equal to 56, and a minimum spacing D2 of the two ejector rods 71 is greater than or equal to 57.

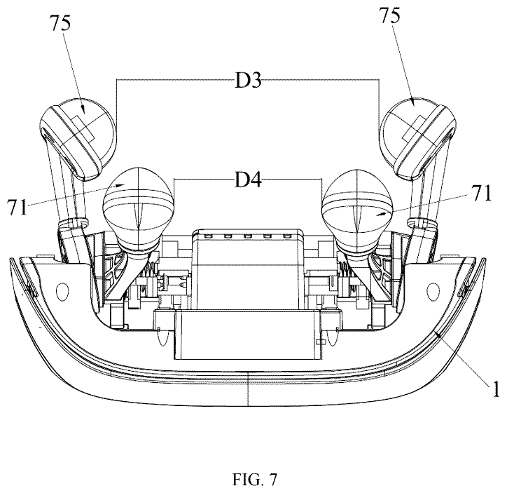

As shown in FIG. 7, when the massage assemblies 7 of the present disclosure are driven by the adjusting screw rods 83 to move outwards to the conducting probe 861 arranged on the outer side, the spacing between the two deflection massage heads 75 and the spacing between the two ejector rods 71 of the two massage assemblies 7 are both the maximum, wherein a maximum spacing D3 of the two deflection massage heads 75 is less than or equal to 133 mm, and a maximum spacing D4 of the two ejector rods 71 is less than or equal to 75 mm. The above embodiments and drawings do not limit the product form and style of the present disclosure, and any appropriate changes or modifications made by a person of ordinary skill in the art shall be deemed as not departing from the patent scope of the present disclosure.

What is claimed is:

1. A massage spacing adjusting structure, comprising: an adjusting motor, an adjusting transmission assembly, two adjusting screw rods, two adjusting seats, two connecting seats and a limiting mechanism, wherein the adjusting transmission assembly connects the adjusting motor and the two adjusting seats, and the two adjusting screw rods, the two adjusting seats and the two connecting seats are symmetrically arranged on a long rotating shaft of a massage machine core respectively; the adjusting seats are connected to the adjusting transmission assembly, a center of each adjusting seat has an internal thread, the adjusting screw rods have external threads in threaded fit with the internal threads of the adjusting seats, one end of each adjusting screw rod is connected to the corresponding adjusting seat, and the other end thereof and a massage assembly are fixed together through the corresponding connecting seat; and the limiting mechanism comprises conducting probes and conducting electrode plates, the conducting probes are connected to a circuit board, the conducting electrode plates synchronously move with the adjusting screw rods, a distance between the two conducting probes is less than or equal to a length of the external thread of each adjusting screw rod, and the conducting electrode plates are located between the two conducting probes.

2. The massage spacing adjusting structure according to claim 1, wherein: the adjusting transmission assembly adopts a gear set for transmission, and comprises an adjusting drive gear, an adjusting transmission shaft and adjusting transmission gears, the adjusting drive gear is meshed with an output shaft of the adjusting motor, the adjusting drive gear is fixedly arranged in the middle of the adjusting transmission shaft, two ends of the adjusting transmission shaft are each connected with one adjusting transmission gear, and peripheries of the adjusting seats have adjusting gears meshed with the adjusting transmission gears.

3. The massage spacing adjusting structure according to claim 2, wherein: the adjusting transmission shaft is provided with a bearing located between the adjusting drive gear and each of the two adjusting transmission gears, the bearings are arranged on bearing seats, and the bearing seats are fixed onto a shell.

4. The massage spacing adjusting structure according to claim 1, wherein: each connecting seat comprises a first clamping ring, a second clamping ring and a connecting member, one end of the connecting member and the massage assembly are locked together, and the other end of the connecting member is provided with a first mounting ring; and one end of each adjusting screw rod connected to the corresponding connecting seat has a second mounting ring, clamping grooves corresponding to the first mounting ring and the second mounting ring are formed in the first clamping ring and the second clamping ring, and when the first clamping ring and the second clamping ring are buckled, the first mounting ring and the second mounting ring are limited in the clamping grooves, so that the massage assembly and the adjusting screw rods are fixed together.

5. The massage spacing adjusting structure according to claim 4, wherein: the conducting electrode plates are mounted on the second clamping rings of the connecting seats, guide rails extend from the second clamping rings towards one end of each adjusting screw rod, the guide rails are provided with electrode plate inserting seats extending towards one end of each conducting probe, and the conducting electrode plates are mounted on the electrode plate inserting seats.

6. A shoulder-neck massage machine core, comprising: a shell, a battery, a massage motor, a circuit board, a massage transmission assembly, a long rotating shaft, massage assemblies and the massage spacing adjusting structure according to claim 1, wherein the battery and the massage motor are connected to the circuit board, the massage transmission assembly connects the massage motor and the long rotating shaft, the long rotating shaft is driven to rotate by a gear transmission set, the two massage assemblies are symmetrically arranged on the long rotating shaft, an adjusting motor is mounted on the shell located on one side of the long rotating shaft, and conducting probes are mounted on the shell.

7. The shoulder-neck massage machine core according to claim 6, wherein: each massage assembly comprises an ejector rod, an eccentric wheel, a deflection wheel and a swing arm, a first limiting column is arranged at a bottom end of the ejector rod, a second limiting column is arranged at a bottom end of the swing arm, and the shell is provided with moving grooves for the first limiting column and the second limiting column to move; the eccentric wheel is provided with an eccentric hole, and is further provided with a long limiting groove communicating with the eccentric hole, the long rotating shaft is provided with two pin holes located at positions corresponding to two ends of the long limiting groove, and the eccentric wheel and the long rotating shaft are fixed together by limiting pins inserted into the two pin holes and the long limiting groove; the eccentric wheel is sleeved with the ejector rod, one end of the ejector rod abuts against the eccentric wheel, the other end thereof and connecting members of connecting seats are locked together, and the ejector rod is positioned on the eccentric wheel through the connecting members; one end of the eccentric wheel is connected to the ejector rod, the other end thereof is connected to an eccentric wheel connecting sheet which is used to fixedly connect the deflection wheel and the eccentric wheel together, one end of the deflection wheel and the eccentric wheel connecting sheet are fixed together, and the other end thereof is provided with a deflection shaft; and one end of the swing arm is provided with a deflection hole corresponding to the deflection shaft, the deflection shaft is sleeved with the deflection hole, one end of the deflection wheel facing away from the deflection shaft forms a deflection slope, and a deflection massage head is mounted at a top end of the swing arm.

8. The shoulder-neck massage machine core according to claim 6, wherein: the massage transmission assembly comprises a drive gear and a transmission gear, the drive gear is a dual gear having a helical gear and a spur gear, the helical gear is meshed with an output shaft of the massage motor, the spur gear is connected and meshed with the transmission gear, and the transmission gear and the long rotating shaft are fixed together.

9. The shoulder-neck massage machine core according to claim 7, wherein: a minimum spacing D1 of the two deflection massage heads of the two massage assemblies is greater than or equal to 56 mm; a minimum spacing D2 of the two ejector rods is greater than or equal to 57 mm; a maximum spacing D3 of the two deflection massage heads is less than or equal to 133 mm; and a maximum spacing D4 of the two ejector rods is less than or equal to 75 mm.
